(19) United States
(12) Patent Application Publication
(10) Pub. No.: US 2025/0156514 A1
(43) Pub. Date: May 15, 2025

(54) AUTHENTICATION

(71) Applicant: Nokia Technologies Oy, Espoo (FI)

(72) Inventors: Marja Pauliina SALMIMAA, Tampere (FI); Tero Simo IIari JOKELA, Tampere (FI); Toni Johan JÂRVENPÄÄ, Tampere (FI); Petri Matti Olavi PIIPPO, Tampere (FI)

(21) Appl. No.: 18/936,788

(22) Filed: Nov. 4, 2024

(30) Foreign Application Priority Data
Nov. 15, 2023 (GB) 2317468.3

(51) Int. Cl. G06F 21/32

(52) U.S. Cl. CPC G06F 21/32

(57) ABSTRACT

The specification describes an apparatus comprising: means for generating electromagnetic radiation; means for enabling capturing one or more biometric features of a user using the electromagnetic radiation, wherein the one or more biometric features of the user are usable for authenticating a user identity of the user; means for transmitting data using said electromagnetic radiation, wherein at least part of the transmitted data is usable for at least one of authenticating or connecting to one or more user devices.

### FIELD

The present specification relates to authentication, particularly in multi-device scenarios.

### BACKGROUND

Performing authentication of devices and users through different means is known. There remains a need for improvement in authentication methods in multi-device systems.

### SUMMARY

In a first aspect, this specification provides an apparatus comprising: means for generating electromagnetic radiation; means for enabling capturing one or more biometric features of a user using the electromagnetic radiation, wherein the one or more biometric features of the user are usable for authenticating a user identity of the user; means for transmitting data using said electromagnetic radiation, wherein at least part of the transmitted data is usable for at least one of authenticating or connecting to one or more user devices.

In some examples, the means for transmitting data comprise means for modulating said electromagnetic radiation at least one of spatially, or temporally.

In some examples, the one or more biometric features of the user comprise blood vessel patterns of the user.

In some examples, the electromagnetic radiation comprises at least one of visible light or infrared radiation.

In some examples, the means for generating electromagnetic radiation comprises means for illuminating a first side of an ear of the user, and wherein the capturing one or more biometric features comprises means for capturing a blood vessel pattern of the ear from a second side of the ear.

In some examples, the means for capturing one or more biometric features comprise one or more imaging sensors.

In some examples, the apparatus is part of one of a mobile communication device, head worn device, or ear worn device.

In some examples, at least one of the one or more user devices is a mobile communication device, head worn device, or ear worn device.

In some examples, the means for generating electromagnetic radiation comprise at least one of one or more infrared light emitting devices, a facial detecting means, a proximity sensor, a device display screen, or a device flashlight.

In some examples, the capturing one or more biometric features is performed at at least one of the one or more user devices.

In some examples, the means comprise: at least one processor; and at least one memory storing instructions that, when executed by the at least one processor, cause the apparatus at least to: generate electromagnetic radiation; enable capturing one or more biometric features of a user using the electromagnetic radiation, wherein the one or more biometric features of the user are usable for authenticating a user identity of the user; transmit data using said electromagnetic radiation, wherein at least part of the transmitted data is usable for at least one of authenticating or connecting to one or more user devices.

In a second aspect, the specification describes a method comprising: generating electromagnetic radiation; enabling capturing one or more biometric features of a user using the electromagnetic radiation, wherein the one or more biometric features of the user are usable for authenticating a user identity of the user; transmitting data using said electromagnetic radiation, wherein at least part of the transmitted data is usable for at least one of authenticating or connecting to one or more user devices.

In some examples, transmitting data comprises modulating said electromagnetic radiation at least one of spatially, or temporally.

In some examples, the one or more biometric features of the user comprise blood vessel patterns of the user.

In some examples, the electromagnetic radiation comprises at least one of visible light or infrared radiation.

In some examples, generating electromagnetic radiation comprises illuminating a first side of an ear of the user, and wherein the capturing one or more biometric features comprises means for capturing a blood vessel pattern of the ear from a second side of the ear.

In some examples, capturing one or more biometric features is performed using one or more imaging sensors.

In some examples, the method is performed in an apparatus that is part of one of a mobile communication device, head worn device, or ear worn device.

In some examples, at least one of the one or more user devices is a mobile communication device, head worn device, or ear worn device.

In some examples, generating electromagnetic radiation is performed using at least one of one or more infrared light emitting devices, a facial detecting means, a proximity sensor, a device display screen, or a device flashlight.

In some examples, the capturing one or more biometric features is performed at at least one of the one or more user devices.

In a third aspect, this specification describes an apparatus configured to perform any method as described with reference to the second aspect.

In a fourth aspect, this specification describes computer-readable instructions which, when executed by computing apparatus, cause the computing apparatus to perform any method as described with reference to the second aspect.

In a fifth aspect, this specification describes a computer program comprising instructions for causing an apparatus to perform at least the following: generating electromagnetic radiation; enabling capturing one or more biometric features of a user using the electromagnetic radiation, wherein the one or more biometric features of the user are usable for authenticating a user identity of the user; transmitting data using said electromagnetic radiation, wherein at least part of the transmitted data is usable for at least one of authenticating or connecting to one or more user devices.

In a sixth aspect, this specification describes a computer-readable medium (such as a non-transitory computer-readable medium) comprising program instructions stored thereon for performing at least the following: generating electromagnetic radiation; enabling capturing one or more biometric features of a user using the electromagnetic radiation, wherein the one or more biometric features of the user are usable for authenticating a user identity of the user; transmitting data using said electromagnetic radiation, wherein at least part of the transmitted data is usable for at least one of authenticating or connecting to one or more user devices.

In a seventh aspect, this specification describes an apparatus comprising: at least one processor; and at least one memory including computer program code which, when executed by the at least one processor, causes the apparatus to: generate electromagnetic radiation; enable capturing one or more biometric features of a user using the electromagnetic radiation, wherein the one or more biometric features of the user are usable for authenticating a user identity of the user; transmit data using said electromagnetic radiation, wherein at least part of the transmitted data is usable for at least one of authenticating or connecting to one or more user devices.

In an eighth aspect, this specification describes an apparatus comprising: a first module configured to generate electromagnetic radiation; a second module configured to enable capturing one or more biometric features of a user using the electromagnetic radiation, wherein the one or more biometric features of the user are usable for authenticating a user identity of the user; and a third module configured to transmit data using said electromagnetic radiation, wherein at least part of the transmitted data is usable for at least one of authenticating or connecting to one or more user devices.

In a ninth aspect, this specification describes an apparatus comprising: means for receiving electromagnetic radiation from a first user device; means for capturing one or more biometric features of a user using the electromagnetic radiation, wherein the one or more biometric features of the user are usable for authenticating a user identity of the user; means for receiving data through said electromagnetic radiation, wherein at least part of the data is usable for at least one of authenticating or connecting to the first user device.

In a tenth aspect, this specification describes a method comprising: receiving electromagnetic radiation from a first user device; capturing one or more biometric features of a user using the electromagnetic radiation, wherein the one or more biometric features of the user are usable for authenticating a user identity of the user; receiving data through said electromagnetic radiation, wherein at least part of the data is usable for at least one of authenticating or connecting to the first user device.

In an eleventh aspect, this specification describes an apparatus configured to perform any method as described with reference to the tenth aspect.

In a twelfth aspect, this specification describes computer-readable instructions which, when executed by computing apparatus, cause the computing apparatus to perform any method as described with reference to the tenth aspect.

In a thirteenth aspect, this specification describes a computer program comprising instructions for causing an apparatus to perform at least the following: receiving electromagnetic radiation from a first user device; capturing one or more biometric features of a user using the electromagnetic radiation, wherein the one or more biometric features of the user are usable for authenticating a user identity of the user; receiving data through said electromagnetic radiation, wherein at least part of the data is usable for at least one of authenticating or connecting to the first user device.

In a fourteenth aspect, this specification describes a computer-readable medium (such as a non-transitory computer-readable medium) comprising program instructions stored thereon for performing at least the following: receiving electromagnetic radiation from a first user device; capturing one or more biometric features of a user using the electromagnetic radiation, wherein the one or more biometric features of the user are usable for authenticating a user identity of the user; receiving data through said electromagnetic radiation, wherein at least part of the data is usable for at least one of authenticating or connecting to the first user device.

In a fifteenth aspect, this specification describes an apparatus comprising: at least one processor; and at least one memory including computer program code which, when executed by the at least one processor, causes the apparatus to: receive electromagnetic radiation from a first user device; capture one or more biometric features of a user using the electromagnetic radiation, wherein the one or more biometric features of the user are usable for authenticating a user identity of the user; receive data through said electromagnetic radiation, wherein at least part of the data is usable for at least one of authenticating or connecting to the first user device.

In a sixteenth aspect, this specification describes an apparatus comprising: a fourth module configured to receive electromagnetic radiation from a first user device; a fifth module configured to capture one or more biometric features of a user using the electromagnetic radiation, wherein the one or more biometric features of the user are usable for authenticating a user identity of the user; and a sixth module configured to receive data through said electromagnetic radiation, wherein at least part of the data is usable for at least one of authenticating or connecting to the first user device.

In a seventeenth aspect, this specification describes a system comprising:
a) an apparatus comprising: means for generating electromagnetic radiation; means for transmitting data using said electromagnetic radiation, wherein at least part of the transmitted data is usable for at least one of authenticating or connecting to said one or more user devices; and
b) a user device comprising: means for receiving the electromagnetic radiation from the apparatus; means for capturing one or more biometric features of a user using the electromagnetic radiation, wherein the one or more biometric features of the user are usable for authenticating a user identity of the user; means for receiving data through said electromagnetic radiation, wherein at least part of the data is usable for at least one of authenticating or connecting to the apparatus.

### BRIEF DESCRIPTION OF THE DRAWINGS

Example embodiments will now be described, by way of example only, with reference to the following schematic drawings, in which:

FIG. 1 is a block diagram of components of a system in accordance with an example embodiment;

FIG. 2 is a flowchart of an algorithm in accordance with an example embodiment;

FIGS. 3 and 4 are block diagrams of systems in accordance with example embodiments;

FIGS. 5 and 6 are flowcharts of algorithms in accordance with example embodiments;

FIGS. 7 and 8 are block diagrams of systems in accordance with example embodiments;

FIG. 9 is a flowchart of an algorithm in accordance with an example embodiment;

FIG. 10 is a block diagram of components of a system in accordance with an example embodiment; and

FIG. 11 shows an example of tangible media for storing computer-readable code which when run by a computer may perform methods according to example embodiments described above.

### DETAILED DESCRIPTION

The scope of protection sought for various embodiments of the invention is set out by the independent claims. The embodiments and features, if any, described in the specification that do not fall under the scope of the independent claims are to be interpreted as examples useful for understanding various embodiments of the invention. In the description and drawings, like reference numerals refer to like elements throughout.

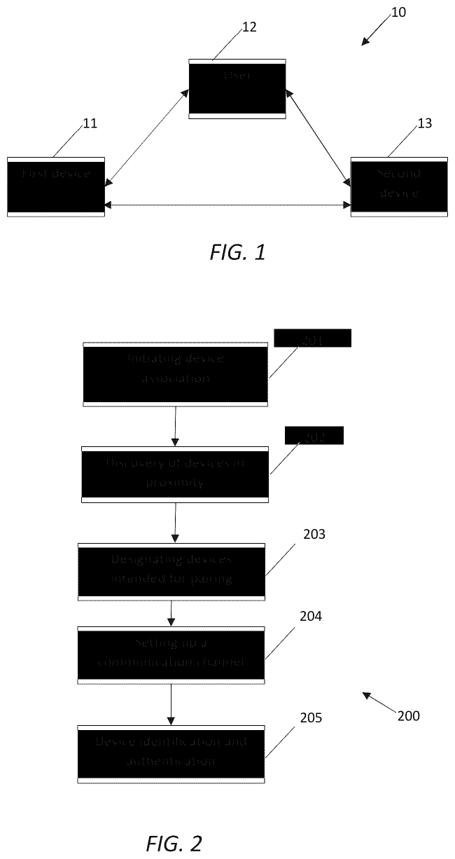

FIG. 1 is a block diagram of a system, indicated generally by the reference numeral 10, in accordance with an example embodiment. The system 10 shows a user 12 who may use multiple devices (e.g. smartphones, tablets, audio devices such as headphones, earphones, ear pods, etc., smartwatch, smart glasses or other types of user devices). The system shows a first device 11 and a second device 13. For example the first and second device 11 and 13 may be two of a plurality of devices that are being used, or that may be used (e.g. owned) by the user 12.

In some examples, identity of the user 12 may need to be authenticated by one or both of the devices 11 and 13. Additionally, or alternatively, in a scenario where the user 12 may wish to use the devices 11 and 13 in conjunction with each other (e.g. pair the devices 11 and 13 for use with each other), the devices 11 and 13 may also need to authenticate each other. For example, the first device 11 may be a smartphone or tablet, and the second device 13 may be an earphone (or any head-worn or ear-worn device such as smart glasses), and the user 12 may wish to pair and connect the two devices 11 and 13 together (e.g. to play audio from the smartphone on the earphones).

Furthermore, if there are a plurality of devices in the proximity of the user 12, the devices 11 and 13 may need to accurately identify each other. Such authentication or identification procedures may generally use Wi-Fi or Bluetooth communication channels for communication between various devices.

User devices such as mobile devices (phones, tablets) and devices (e.g. peripheral devices) that are used with such mobile devices, such as earphones, headphones, speakers, smartwatches, or the like, are used by individuals on a regular basis. In order to use a plurality of such devices together (e.g. perform multi-device interactions), device association (pairing or other coupling methods) between the devices may need to be initiated.

Because wireless communication is invisible to a user (e.g. the user cannot see the wireless links between the devices), the user may not be sure which devices are actually being connected, which may open a possibility for security breaches (e.g. Man-in-the-Middle attacks where a malicious third party may secretly relay, monitor, and possibly modify communication between the two parties who assume that they are directly communicating with each other). As such, in multi-device systems, improved authentication techniques may be desirable.

The procedure of connecting devices for multi-device interactions may be referred to as device binding or ecosystem binding, device association, pairing, or coupling.

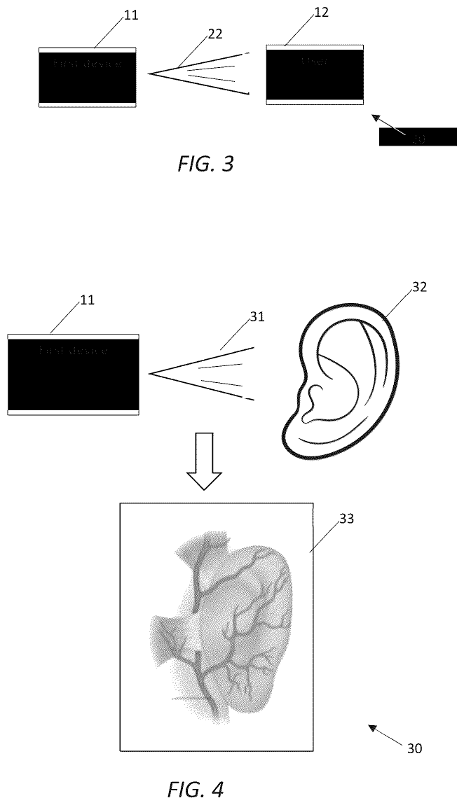

FIG. 2 is a flowchart of an algorithm, indicated generally by the reference numeral 200, in accordance with an example embodiment. The algorithm 200 may relate to an example procedure of device association, which procedure may be performed once the user is authenticated. The algorithm 200 may be performed at one or both of the devices 11 and 13. The algorithm 200 may start at operation 201, where device association may be initiated (e.g. launching required system and application software). Next, at operation 202, discovery of devices in proximity may be performed. At operation 203, one or more devices may be designated, which devices that are intended to be associated with (e.g. paired or coupled with). At operation 204, a communication channel may be set up (e.g. WiFi, Bluetooth, or other short range radio technologies) for enabling exchange of data and coordination of user interactions between the device(s). At operation 205, device identification and/or authentication may be performed.

In some examples, biometric identification techniques can be used for the user authentication. Specifically, the analysis of the patterns of blood vessels may be used to identify the user, as subcutaneous blood vessels of the human body form a distinctive pattern for each person.

Some example embodiments below provide improved techniques for performing said authentication and/or identification procedures.

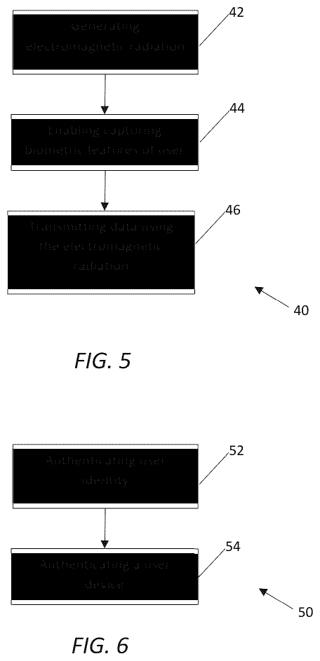

FIG. 3 is a block diagram of a system, indicated generally by the reference numeral 20, in accordance with an example embodiment. The system 20 shows the first device 11 and the user 12, where the first device 11 generates electromagnetic radiation 22 towards the user 12. For example, the electromagnetic radiation 22 may illuminate one or more body parts of the user 12, so as to enable capturing of one or more biometric features of the user 12. For example, one or more of the biometric features of the user 12 may be usable for authenticating the user 12 for using one or more of the devices 11 or 13.

FIG. 4 is a block diagram of a system, indicated generally by the reference numeral 30, in accordance with an example embodiment. The system 30 shows the first device 11 and an ear 32 (e.g. ear of the user 12), where the first device 11 generates electromagnetic radiation 31 towards the ear 32. For example, the electromagnetic radiation 31 may illuminate the ear 32, so as to enable capturing of one or more biometric features of the user 12. For example, the illumination may enable capturing an image 33 of the ear 32, where the image 33 comprises biometric features, such as blood vessel pattern(s), of the user 12 (specifically blood vessel patterns of the ear 32). Blood vessel pattern(s) of a user may be unique to that user, such that a user may be identified and/or authenticated accurately based on identification of the blood vessel pattern(s). In some examples, shape of a user's ear 32 may also be unique to the user, such that the shape may be captured and used for authenticating a user.

In some examples, the electromagnetic radiation (22, 31) may be used for data communication, for example, by modulating the electromagnetic radiation spatially and/or temporally. The modulation procedure may be dependent on the wavelength of the electromagnetic radiation. For example, the first device 11 may send data (e.g. for device identification and/or authentication) to the second device 13 via a communication channel formed through the electromagnetic radiation (22,31). The second device 13 may need to be in proximity of the first device 11 in order to communicate via a communication channel formed through the electromagnetic radiation (22,31).

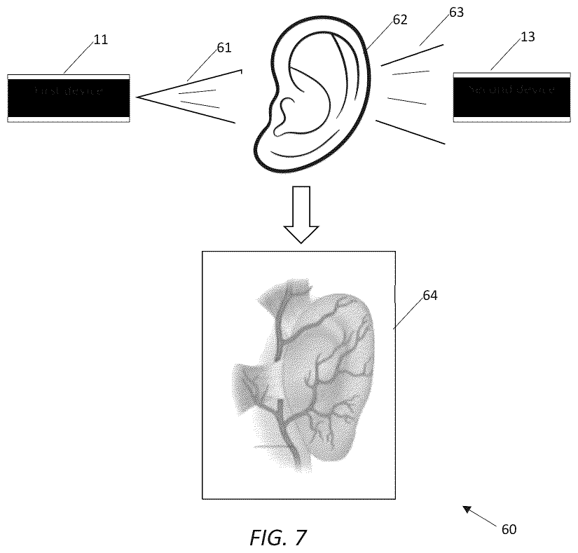

FIG. 5 is a flowchart of an algorithm, indicated generally by the reference numeral 40, in accordance with an example embodiment.

The algorithm 40 may start with operation 42, where an electromagnetic radiation (22,31) may be generated, for example, by the first device 11. Next, at operation 44, capturing of one or more biometric features of the user 12 may be enabled using said electromagnetic radiation. For example, the one or more biometric features may be captured by the first device 11 (e.g. by way of reflected electromagnetic radiation) and/or by the second device 13 (e.g. by way of reflected electromagnetic radiation or the electromagnetic radiation transmitted through tissue of the user's body part, such as an ear). In one example, one of the devices 11 and 13 may capture the one or more biometric features, and then may send information of the captured one or more biometric features to the other one of the devices 11 and 13. The one or more biometric features of the user may be usable for authenticating a user identity of the user. At operation 46, data may be transmitted (e.g. by the first device 11 to the second device 13, or vice versa) using the electromagnetic radiation (e.g. through a first communication channel formed through the electromagnetic radiation). At least part of the transmitted data may be usable for at least one of authenticating or connecting to one or more user devices. In some examples, data may be transmitted by way of modulating the electromagnetic radiation spatially and/or temporally.

In some examples, after the first device 11 is connected to the second device 13 using the first communication channel formed through the electromagnetic radiation (22, 31), the devices 11 and 13 may continue communicating through said first communication channel, although that would require the devices 11 and 13 to remain in close proximity (e.g. so that the electromagnetic radiation generated by the first device 11 may be captured by the second device 13). Alternatively, or in addition, the devices 11 and/or 13 may set up a second communication channel (e.g. via Wifi, Bluetooth, or other short range radio communication) in order to communicate once the devices have been authenticated with each other. For example, the first communication channel may be used for exchanging information (e.g. initialization information) required for setting up the second communication channel. The second communication channel may provide a better speed and the connection may have a wider range (e.g. the devices 11 and 13 may be farther apart from each other) than the first communication channel. As such, the first communication channel may be used for an initial secure connection through which the devices may be identified and authenticated, and subsequently the devices may communicate through the second communication channel.

FIG. 6 is a flowchart of an algorithm, indicated generally by the reference numeral 50, in accordance with an example embodiment.

At operation 52, a user identity is authenticated, for example, based on the one or more biometric features captured at operation 44. For example, the one or more biometric features may comprise the blood vessel (e.g. vein) patterns of the user, which may be unique to each user, and may thus be usable for authenticating the user identity. The user identity may be authenticated at one or both the devices 11 and 13. In one example, only one of the devices 11 and 13 may authenticate the user identity, and may communicate to the other one of the devices 11 and 13 that the user identity has been authenticated.

At operation 54, a user device, such as the first device 11 and/or the second device 13, may be authenticated and/or identified, based, at least in part, on the data transmitted using the electromagnetic radiation (22, 31). For example, the first device 11 may transmit data to and/or receive data from the second device 13 via a communication channel formed through the electromagnetic radiation, where the data may comprise authentication and/or identification information relating to first device 11 and/or the second device 13. Similarly, the second device 13 may transmit data to and/or receive data from the first device 11 via a communication channel formed through the electromagnetic radiation, where the data may comprise authentication and/or identification information relating to the first device 11 and/or the second device 13.

As such, the example embodiments may provide techniques for user authentication, device authentication, and secure communication channel setup for the creation of multidevice ecosystem and device-to-device communication. In an example embodiment, the communication between the first device 11 and second device 13 may be set up such that the data being transferred may be encoded using information of one or more biometric features (e.g. captured at operation 44) of the user 12. Said encoding may be suitable for associating a plurality of devices with each other for use by a specific user.

In one example, the first device 11 and/or the second device 13 may be any handheld or head worn device that may comprise at least one of: a) a photo detector and/or imaging sensor (e.g. for capturing biometric feature(s) of the user); or b) module for generating electromagnetic radiation (e.g. illumination) for communication between devices (e.g. including communication for device identification and/or authentication) and/or authentication of the user (e.g. blood vessel pattern capture). For example, the first device 11 and/or the second device 13 may be a mobile phone, earbuds or a headset for augmented reality, virtual reality and/or mixed reality applications. For example, the user (e.g. user 12) may wear a headset (e.g. first device 11) and may hold their mobile phone (e.g. second device 13) near their ear such that one of the devices may generate illumination, such that said device, or the other device may capture a blood vessel pattern of the user's ear for user authentication, and said illumination may be used for pairing the mobile phone and the headset with each other (device identification and/or authentication between the headset and the mobile phone). A similar procedure may also be used for pairing the mobile phone and/or headset with audio devices such as earphones, earbuds, or the like.

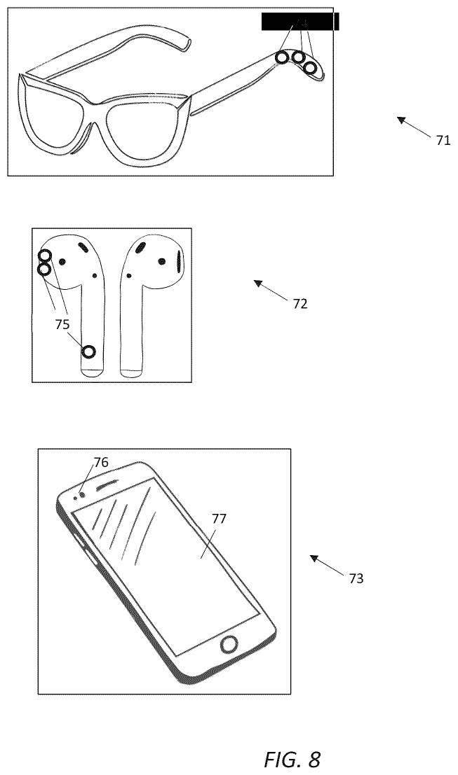

FIG. 7 is a block diagram of a system, indicated generally by the reference numeral 60, in accordance with an example embodiment. The first device 11 may generate (e.g. operation 42) electromagnetic radiation 61 at an ear 62 of a user (e.g. user 12). For example, the electromagnetic radiation 61 may illuminate a first side of the ear 62. The electromagnetic radiation 61 may pass through the ear 62 and may reach the second device 13 as electromagnetic radiation 63 (e.g. polarization of the electromagnetic radiation 61 may change when it passes through the tissue of the ear 62). The second device 13 may then capture one or more biometric features of the user from an image of the ear 62 (e.g. earlobe), where the biometric features may comprise blood vessel pattern(s) of the ear 62 (e.g. earlobe, outer ear (pinna), and/or ear canal).

For example, the second device 13 may comprise photodetectors and/or image sensors (e.g. organic photo detector sensing technologies) for capturing image 64, where image 64 comprises blood vessel pattern(s) of at least part of the ear 62 (e.g. earlobe, outer ear (pinna), and/or ear canal). The blood vessel pattern (biometric features) may be unique to the user, such that the user may be authenticated based on the image 64. The authentication may be performed at one or both of the devices 11 and 13. The electromagnetic radiation 61 and/or 63 may be used for transferring data between the first device 11 and the second device 13, where the data may be encoded (e.g. with information of biometric features of the user), and may be used for device identification and/or authentication and may further be used for setting up a further communication channel for subsequent communication between the first device 11 and second device 13.

In an example embodiment, prior to performing user authentication, information of the user's biometric features (e.g. blood vessel patterns of one or each of the user's ears, or specifically the earlobes, outer ear, and/or ear canal) may be stored, for example at one or both of the devices 11 and 13, or remotely at a server (e.g. cloud server). The user authentication may then be performed based on whether the captured biometric features match the stored biometric features.

In one example, device borrowing may be enabled by allowing other users' biometric features to be stored and/or shared prior to user authentication. For example, a user who is not the owner of a device may be identified as a user with limited access. As such, if biometric features of a user are captured, and it is identified that the user is not the owner of the device, said user may be authenticated to be able to have limited access to the device (e.g. only allowed to use applications and/or functions defined by a primary user (owner) or predefined in default settings of the device (e.g. a camera of a mobile device, personalization settings (e.g. brightness, volume, or the like), flashlight), but restricted from using other functionalities of the mobile device).

In an example embodiment, for initially capturing and storing the user's biometric features, user interface guidance may be provided (e.g. by the first device 11) to the user for positioning the first device 11 accurately for illuminating the ear 62 (or at least part of the ear 62, such as the earlobe, outer ear, and/or ear canal). One or more images of at least part of the ear 62 may be captured, and the one or more images may be analysed using pattern recognition techniques for determining one or more biometric features (e.g. blood vessel patterns). As such, one or more unique features and/or patterns of the blood vessels may be identified and encoded into a template for the user's ear. The template may then be stored securely at a user device (e.g. first device 11, mobile phone of the user), or at a network server. In one example, blood vessel patterns for the template can be captured by illuminating at least part of the ear with visible or infrared light (electromagnetic radiation), and photographing the reflected light (e.g. by the same device that generates the light) or transmitted light (e.g. by another device on another side of at least part of the ear), as blood vessels absorb infrared light more than the surrounding tissue and appear darker in the acquired image.

FIG. 8 is a block diagram in accordance with an example embodiment. FIG. 8 shows a plurality of examples of user devices, indicated generally by the reference numerals 71, 72, and 73 respectively. User device 71 shows a head-worn device (e.g. smart-glasses, headset for virtual reality, augmented reality, and/or mixed reality). User device 72 shows earpods. User device 73 shows a mobile device.

User device 71 may comprise means 74 for generating electromagnetic radiation. For example, the means 74 may be located near the ears of a user when the user device 71 is worn by the user, such that the means may generate electromagnetic radiation usable for capturing blood vessel patterns of one or each of the user's ears. In one example, the means 74 may comprise infrared one or more light emitting devices (e.g. LED array) which generate infrared radiation. In another example, the means 74 may comprise a proximity sensor, which may generate electromagnetic radiation such as infrared radiation.

User device 72 may comprise means 75 for generating electromagnetic radiation. For example, the means 75 may be located near the ears of a user when the user device 75 is worn by the user, such that the means may generate electromagnetic radiation usable for capturing blood vessel patterns of the user's ears. In one example, the means 75 may comprise one or more infrared light emitting devices which generate infrared radiation. In another example, the means 75 may comprise a proximity sensor, which may generate electromagnetic radiation such as infrared radiation.

User device 73 (mobile device) may comprise means 76 and/or means 77 for generating electromagnetic radiation. For example, means 76 may be a facial detecting means (e.g. face identity projector) of the user device 73. The facial detecting means may produce infrared emission of wavelengths above 780 nm, which may be used for capturing blood vessel patterns of the ear of the user when the mobile device is held near the user's ear.

In another example, the means 77 may comprise the display of the mobile phone, which may generate visible light and/or infrared light for illumination of the user's ear when the mobile device is held near the user's ear, thus enabling capturing of blood vessel patterns of the user's ear.

In another example, the user device 73 may comprise a proximity sensor that may be embedded in the user device 73, which proximity sensor produces infrared radiation usable for capturing biometric features of the user.

In another example, the user device 73 may comprise a flash light (white light emitting device) which may generate visible light with wavelengths in the range 400 nm to 750 nm. The flash light may generate light in two modes, such as a normal imaging mode and blood vessel illumination mode, where the two modes may generate light of different wavelengths. For example, the blood vessel illumination mode may be used for generating illumination suitable for capturing blood vessel pattern(s) of the user's ear.

In some examples, one or more of the user devices 71, 72, and 73 may further comprise means for receiving electromagnetic radiation and/or capturing one or more biometric features of the user. For example, the means for receiving electromagnetic radiation may comprise sensors (e.g. photodetector, infrared radiation sensor, or the like) that may detect electromagnetic radiation, and may in turn capture one or more biometric features of one or each of the user's ear. In some examples, the same user device (71, 72, 73) may be able to generate the illumination, as well as receive the illumination (e.g. reflected electromagnetic radiation) and capture the one or more biometric feature. Alternatively, a first user device (e.g. user device 73 such as a mobile phone) may generate the illumination, and a second user device (e.g. user device 72, such as earpods) may receive the illumination and capture the one or more biometric features, or vice versa.

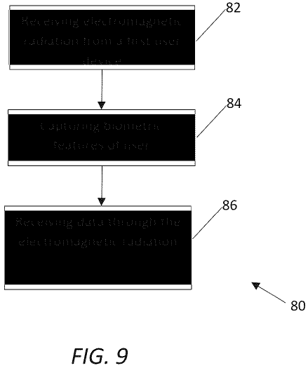

FIG. 9 is a flowchart of an algorithm, indicated generally by the reference numeral 80, in accordance with an example embodiment. For example, the algorithm 80 may be performed at the first user device 11 (e.g. same device that generates the electromagnetic radiation), or may be performed at the second user device 13.

Operation 82 comprises receiving electromagnetic radiation from a first user device, such as the first user device 11. For example, if the operation 82 is being performed at the first device 11, the received electromagnetic radiation may be a reflected electromagnetic radiation (e.g. reflected from an ear of the user). Alternatively, if the operation 82 is being performed at the second device 13, the received electromagnetic radiation may be received through a tissue of an ear of the user.

At operation 84, one or more biometric features of a user may be captured using the electromagnetic radiation. The one or more biometric features of the user may be usable for authenticating a user identity of the user. As discussed earlier, the one or more biometric features may be captured using a photo detector and/or imaging sensor.

At operation 86, data may be received through said electromagnetic radiation. At least part of the data may be usable for at least one of authenticating or connecting to the first user device. The data may be based on modulating of the said electromagnetic radiation spatially and/or temporally.

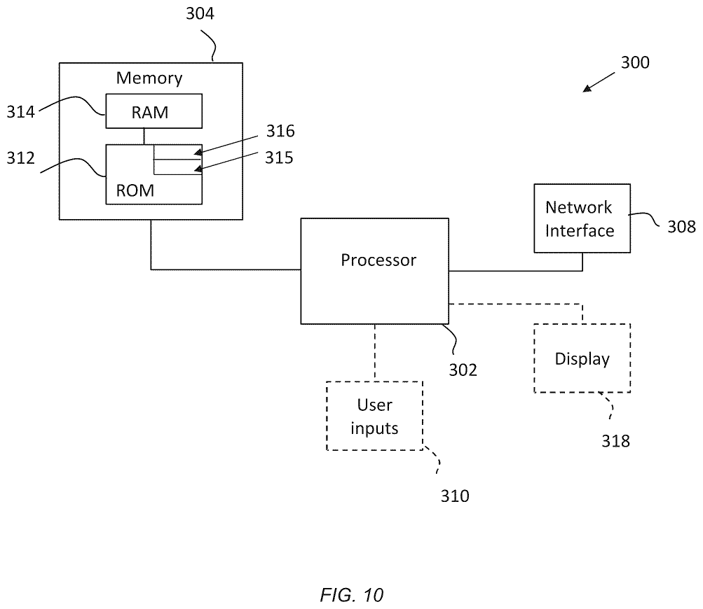

For completeness, FIG. 10 is a schematic diagram of components of one or more of the example embodiments described previously, which hereafter are referred to generically as processing systems 300. A processing system 300 may have a processor 302, a memory 304 closely coupled to the processor and comprised of a RAM 314 and ROM 312, and, optionally, user input 310 and a display 318. The processing system 300 may comprise one or more network/apparatus interfaces 308 for connection to a network/apparatus, e.g. a modem which may be wired or wireless. Interface 308 may also operate as a connection to other apparatus such as device/apparatus which is not network side apparatus. Thus, direct connection between devices/apparatus without network participation is possible.

The processor 302 is connected to each of the other components in order to control operation thereof.

The memory 304 may comprise a non-volatile memory, such as a hard disk drive (HDD) or a solid-state drive (SSD). The ROM 312 of the memory 304 stores, amongst other things, an operating system 315 and may store software applications 316. The RAM 314 of the memory 304 is used by the processor 302 for the temporary storage of data. The operating system 315 may contain computer program code which, when executed by the processor implements aspects of the algorithms 200, 40, 50, and 80 described above. Note that in the case of small device/apparatus the memory can be most suitable for small size usage i.e. not always hard disk drive (HDD) or solid-state drive (SSD) is used.

The processor 302 may take any suitable form. For instance, it may be a microcontroller, a plurality of microcontrollers, a processor, or a plurality of processors.

The processing system 300 may be a standalone computer, a server, a console, or a network thereof. The processing system 300 and needed structural parts may be all inside device/apparatus such as IoT device/apparatus i.e. embedded to very small size

In some example embodiments, the processing system 300 may also be associated with external software applications. These may be applications stored on a remote server device/apparatus and may run partly or exclusively on the remote server device/apparatus. These applications may be termed cloud-hosted applications. The processing system 300 may be in communication with the remote server device/apparatus in order to utilize the software application stored there.

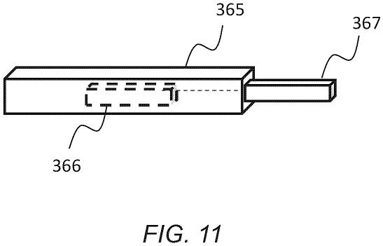

FIG. 11 shows tangible media, specifically a removable memory unit 365, storing computer-readable code which when run by a computer may perform methods according to example embodiments described above. The removable memory unit 365 may be a memory stick, e.g. a USB memory stick, having internal memory 366 for storing the computer-readable code. The internal memory 366 may be accessed by a computer system via a connector 367. Other forms of tangible storage media may be used. Tangible media can be any device/apparatus capable of storing data/information which data/information can be exchanged between devices/apparatus/network.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any non-transitory media or means that can contain, store, communicate, propagate or transport the instructions for use by or in connection with an instruction execution system, apparatus, or device, such as a computer.

Reference to, where relevant, “computer-readable storage medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialised circuits such as field programmable gate arrays FPGA, application specify circuits ASIC, signal processing devices/apparatus and other devices/apparatus. References to computer program, instructions, code etc. should be understood to express software for a programmable processor firmware such as the programmable content of a hardware device/apparatus as instructions for a processor or configured or configuration settings for a fixed function device/apparatus, gate array, programmable logic device/apparatus, etc.

As used in this application, the term “circuitry” refers to all of the following: (a) hardware-only circuit implementations (such as implementations in only analogue and/or digital circuitry) and (b) to combinations of circuits and software (and/or firmware), such as (as applicable): (i) to a combination of processor(s) or (ii) to portions of processor(s)/software (including digital signal processor(s)), software, and memory (ies) that work together to cause an apparatus, such as a server, to perform various functions) and (c) to circuits, such as a microprocessor(s) or a portion of a microprocessor(s), that require software or firmware for operation, even if the software or firmware is not physically present.

If desired, the different functions discussed herein may be performed in a different order and/or concurrently with each other. Furthermore, if desired, one or more of the above-described functions may be optional or may be combined. Similarly, it will also be appreciated that the flow charts of FIGS. 2, 5, 6 and 9 are examples only and that various operations depicted therein may be omitted, reordered and/or combined.

It will be appreciated that the above described example embodiments are purely illustrative and are not limiting on the scope of the invention. Other variations and modifications will be apparent to persons skilled in the art upon reading the present specification.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1-15. (canceled)

16. An apparatus comprising:
at least one processor; and
at least one memory storing instructions that, when executed by the at least one processor, cause the apparatus at least to:
generate electromagnetic radiation;
enable capturing one or more biometric features of a user using the electromagnetic radiation, wherein the one or more biometric features of the user are usable for authenticating a user identity of the user;
transmit data using said electromagnetic radiation, wherein at least part of the transmitted data is usable for at least one of authenticating or connecting to one or more user devices.

17. An apparatus as claimed in claim 16, wherein the apparatus is further caused to encode the data to be transmitted using information from the captured one or more biometric features of the user.

18. An apparatus as claimed in claim 16, wherein the transmitted data is transmitted to one of the one or more user devices through a first communication channel formed through the electromagnetic radiation.

19. An apparatus as claimed in claim 18, wherein the apparatus is further caused to set up a second communication channel to communicate with said one of the one or more user devices, after the apparatus and said one of the one or more user devices have been authenticated with each other.

20. An apparatus as claimed in claim 19, wherein the first communication channel is used for an initial secure connection through which said one of the one or more user devices is identified and authenticated, and subsequently the apparatus and said one of the one or more user devices communicate through the second communication channel.

21. An apparatus as claimed in claim 16, wherein the apparatus is further caused to:
modulate said electromagnetic radiation at least one of spatially, or temporally.

22. An apparatus as claimed in claim 16, wherein the one or more biometric features of the user comprise blood vessel patterns of the user.

23. An apparatus as claimed in claim 16, wherein the electromagnetic radiation comprises at least one of visible light or infrared radiation.

24. An apparatus as claimed in claim 16, wherein the apparatus further comprises:
a light source configured to illuminate a first side of an ear of the user; and
at least one of: one or more photodetectors or one or more imaging sensors configured to capture a blood vessel pattern of the ear from a second side of the ear.

25. An apparatus as claimed in claim 16, wherein the apparatus is part of one of a mobile communication device, a head worn device, or an ear worn device.

26. An apparatus as claimed in claim 16, wherein at least one of the one or more user devices is a mobile communication device, a head worn device, or an ear worn device.

27. An apparatus as claimed in claim 16, wherein the apparatus further comprises at least one of: one or more infrared light emitting devices, a facial detector, a proximity sensor, a device display screen, or a device flashlight.

28. An apparatus as claimed in claim 16, wherein the apparatus is further configured to cause at least one of the one or more user devices to capture the one or more biometric features.

29. An apparatus comprising:
at least one processor; and
at least one memory storing instructions that, when executed by the at least one processor, cause the apparatus at least to:
receive electromagnetic radiation from a first user device;
capture one or more biometric features of a user using the electromagnetic radiation, wherein the one or more biometric features of the user are usable for authenticating a user identity of the user;
receive data through said electromagnetic radiation, wherein at least part of the data is usable for at least one of authenticating or connecting to the first user device.

30. An apparatus as claimed in claim 29, wherein the received data is received from the first user device through a first communication channel formed through the electromagnetic radiation.

31. An apparatus as claimed in claim 30, wherein the apparatus is further caused to set up a second communication channel to communicate with said first user device, after the apparatus and said first user device have been authenticated with each other.

32. An apparatus as claimed in claim 31, wherein the first communication channel is used for an initial secure connection through which said first user device is identified and authenticated, and subsequently the apparatus and said first user device communicate through the second communication channel.

33. A non-transitory computer readable medium comprising program instructions stored thereon for causing an apparatus to perform at least the following:
generating electromagnetic radiation;
enabling capturing one or more biometric features of a user using the electromagnetic radiation, wherein the one or more biometric features of the user are usable for authenticating a user identity of the user; and
transmitting data using said electromagnetic radiation, wherein at least part of the transmitted data is usable for at least one of authenticating or connecting to one or more user devices.

34. The non-transitory computer readable medium of claim 33, wherein the transmitted data is transmitted to one of the one or more user devices through a first communication channel formed through the electromagnetic radiation.

35. The non-transitory computer readable medium of claim 34, wherein the program instructions are further configured to cause the apparatus to:
set up a second communication channel to communicate with said one of the one or more user devices, after the apparatus and said one of the one or more user devices have been authenticated with each other;
wherein the first communication channel is used for an initial secure connection through which said one of the one or more user devices is identified and authenticated, and subsequently the apparatus and said one of the one or more user devices communicate through the second communication channel.
